(19) United States
(12) Patent Application Publication
(10) Pub. No.: US 2015/0256465 A1
(43) Pub. Date: Sep. 10, 2015

(54) Software-Defined Network Control Using Control Macros

(71) Applicant: Futurewei Technologies, Inc., Plano, TX (US)

(72) Inventors: Thomas Benjamin Mack-Crane, Downers Grove, IL (US); Young Lee, Plano, TX (US); Maarten Vissers, Huizen (NL)

(21) Appl. No.: 14/635,515

(22) Filed: Mar. 2, 2015

Related U.S. Application Data
(60) Provisional application No. 61/947,892, filed on Mar. 4, 2014.

(51) Int. Cl. H04L 12/851; H04L 29/08

(52) U.S. Cl. CPC H04L 47/2441; H04L 67/12

(57) ABSTRACT

A method implemented by a network controller in a software-defined network (SDN), the method comprising obtaining a first control macro (CM) that defines at least one first flow pattern, wherein the first CM comprises at least one command and at least one parameter associated with the command, identifying a first network function associated with the first flow pattern and a first network node, determining a parameter value for the parameter according to the first network function, and sending a first CM invocation message to the first network node to request execution of the first CM to establish the first network function, wherein the first CM invocation message comprises the parameter value.

### CROSS-REFERENCE TO RELATED APPLICATIONS

The present application claims priority to U.S. Provisional Patent Application 61/947,892, filed Mar. 4, 2014 by T. Benjamin Mack-Crane, et. al., and entitled “Software Defined Network Control Using Control Macros,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Software-defined networks (SDNs) have emerged as a promising technology. In SDNs, network control is decoupled from forwarding and is programmable, for example, by separating the control plane from the data plane and implementing the control plane using software applications and a centralized SDN controller, which makes routing decisions and communicates the routing decisions to all the network devices on the network. This migration from tightly bound individual network device control to control using accessible computing devices has enabled the underlying infrastructure to be abstracted for applications and network services, permitting treatment of the network as a logical entity. Open application programming interfaces (APIs), such as OpenFlow as described in the “OpenFlow switch specification version 1.4.0,” Oct. 14, 2013, which is incorporated herein by reference, standardizes the interactions between the data plane and the control plane, allowing network devices and network controllers with firmware from different vendors to communicate with each other.

### SUMMARY

In one embodiment, the disclosure includes a method implemented by a network controller in an SDN, the method comprising obtaining a first control macro (CM) that defines at least one first flow pattern, and wherein the first CM comprises at least one command and at least one parameter associated with the command, identifying a first network function associated with the first flow pattern and a first network node, determining a parameter value for the parameter according to the first network function, and sending a first CM invocation message to the first network node to request execution of the first CM to establish the first network function, wherein the first CM invocation message comprises the parameter value.

In another embodiment, the disclosure includes a network element (NE) comprising a receiver configured to couple to an SDN controller, a memory configured to store a flow table, and a processor coupled to the memory and the receiver, wherein the processor is configured to obtain a first CM comprising a CM identifier (CMID) that identifies the first CM, at least one command, and at least one parameter associated with the command, wherein the first CM defines a first flow pattern, store the first CM in the memory, receive, via the receiver, a first CM request from the SDN controller to invoke the first CM, wherein the first CM request indicates a value for the parameter, and wherein the value is associated with a network function on the NE, and execute the command in the first CM by substituting the value for the parameter in response to the first CM request, wherein executing the command causes addition of at least a first flow table entry in the flow table, and wherein the first flow table entry identifies a flow associated with the first flow pattern and the network function.

In yet another embodiment, the disclosure includes a computer program product for use by an SDN-enabled network, wherein the computer program product comprises computer executable instructions stored on a non-transitory computer readable medium that when executed by a processor causes the SDN-enabled network node to receive a CM comprising a CMID that identifies the CM, a parameter, and a plurality of commands, wherein at least one of the commands comprises an argument associated with the parameter, store the CM in a memory device, and receive a request to invoke the CM for configuring a network function, wherein the request provides a parameter value for the parameter, and wherein the parameter value is associated with the network function.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of an SDN-based system.

FIG. 2 is a schematic diagram of an embodiment of an OpenFlow network.

FIG. 3 is a schematic diagram of an embodiment of an NE acting as a node in an SDN.

FIG. 4 is a protocol diagram of an embodiment of a method for configuring a network comprising multiple flows with common flow patterns.

FIG. 5 is a protocol diagram of an embodiment of a method for associating multiple controls that operate on a network connection.

FIG. 6 is a flowchart of an embodiment of a method for configuring a network comprising multiple flows with common flow patterns.

FIG. 7 is a flowchart of an embodiment of a method for processing CMs.

FIG. 8 is a schematic diagram of an embodiment of a CM structure.

FIG. 9 is a schematic diagram of an embodiment of a CM invocation structure.

FIG. 10 illustrates an embodiment of a CM definition with parameter identifiers (IDs) in place of command argument values.

FIG. 11 illustrates an embodiment of a CM definition with parameter association.

FIG. 12 illustrates an embodiment of a CM invocation.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalent.

Although the OpenFlow protocol provides a standard communication interface between network controllers and network devices in SDNs, such as switches, bridges, and routers, the OpenFlow protocol provides relatively simple or limited control of packet and/or flow processing at the network devices. For example, a network controller is responsible for managing and configuring every network devices in an SDN with every flow that is intercepted by the network devices. However, many networks comprise multiple flows with similar flow patterns, which are processed by performing similar operations. A flow pattern is also referred to as a match-action pattern, which is a set of matching rules and a set of actions corresponding to the set of matching rules. The set of matching rules identifies a flow, and the set of actions describes the processing of a packet that matches to the flow. As a result, a network device may be configured with a large number of flow table entries with similar match-action patterns, which not only increases the amount of controller-switch traffic, but may also delay packet processing. In addition, some flows are associated with each other, and thus it may be beneficial to operate the associated flows uniformly and/or simultaneously.

The OpenFlow protocol version 1.4.0 introduced synchronized tables and bundles to enable grouping of related state changes on a network device so that the related state changes are applied simultaneously. For example, synchronized tables enable automatic synchronization between the creations, modifications, and/or deletions of multiple flow tables or flow table entries. However, the effects, translations, and/or transformations between the multiple flow tables and/or flow table entries are not fully specified and may not be easily controlled by a network controller. Thus, the employments of synchronized tables may not be practical. Similarly, bundles provide some control synchronizations by enabling a network controller to send a list of OpenFlow commands to a network device and instruct the network device to execute the list of OpenFlow commands simultaneously. However, a bundle is executed once and deleted after execution. In addition, a bundle is directed towards one or more specific flows, and thus may not be reused for different flows.

Another example protocol for managing network devices is the network configuration (NETCONF) protocol described in Internet Engineering Task Force (IETF) document Request for Comment (RFC) 6241, which is incorporated herein by reference. The NETCONF protocol provides mechanisms for installing, manipulating, and deleting configurations in network devices. Some configurations may be associated with each other, and thus providing mechanisms for programming similar or consistent behavior patterns uniformly may be beneficial to network management.

Disclosed herein are embodiments for efficiently configuring network devices in a network comprising flows with common flow patterns. The disclosed embodiments provide mechanisms for employing CMs to describe common flow patterns, enabling the reuse of CMs through parameters, and associating different CMs by performing parameter bindings. A CM is created by providing a CMID, adding a set of one or more commands to describe one or more match-action patterns that are common to multiple flows in the network, and including one or more parameters that are substituted for values specific to a connection and/or a flow upon CM invocation. A connection refers to a link between two or more connection points and comprises one or more flows. The invocation of a CM refers to the execution of the CM commands or an instantiation of an instance of the CM. To create a connection, a CM is invoked with values for the parameters, where the values are specific to the connection. Invoking the CM causes execution of the commands in the CM with the values substituted for the parameters. To describe a specific connection, a set of parameters is bound with values specific to the connection, for example, in the form of parameter name-value pairs. The bind of the set of parameters to the specific values is represented by a binding identifier (BID). As such, multiple control operations or CMs that operate on the same connection may be associated through the BID. For example, after a connection is created with a BID, subsequent invocations of CMs associated with the connection may reference the BID. A connection is deleted by referencing the BID. A CM is deleted by referencing the CMID. The disclosed mechanisms are applicable to any SDNs. The OpenFlow protocol may be extended to incorporate the disclosed mechanisms to provide more efficient network controls and/or configurations. It should be noted that a flow pattern may represent any pattern of configuration that may be created using a set of commands. Although the disclosed embodiments are described in the context of network connections, the disclosed embodiments are suitable for any types of network functions associated with configuration patterns. For example, the disclosed mechanisms may be applied to the NETCONF protocol described in the IETF document RFC 6241 to configure network management functions.

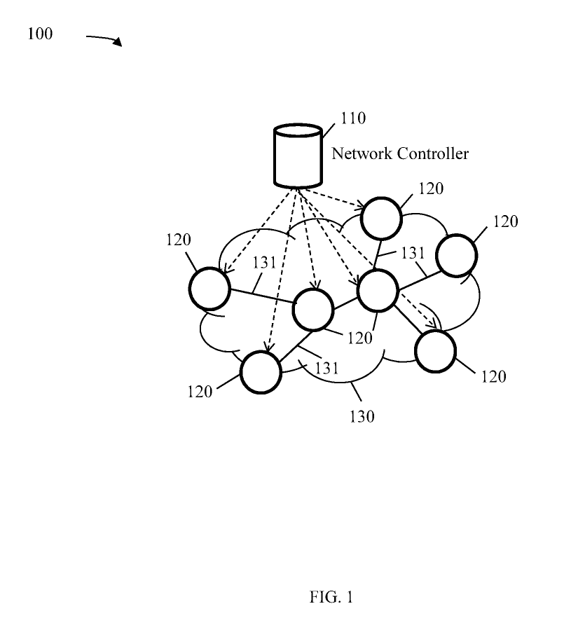

FIG. 1 is a schematic diagram of an embodiment of an SDN-based system 100. The system 100 comprises a transport network 130 coupled to a network controller 110. The network 130 comprises a plurality of network nodes 120 interconnected by a plurality of links 131. The network 130 may comprise a single networking domain or multiple networking domains. In an embodiment, the network 130 comprises a single network domain managed by a single network controller 110. In another embodiment, the network 130 is partitioned into multiple network domains and each network domain may be coupled to a network controller 110. In yet another embodiment, the system 100 may comprise a single network domain coupled to multiple network controllers 110. The links 131 may comprise physical links, such as fiber optic links and/or electrical links, logical links, and or combinations thereof used to transport data.

The network controller 110 may be a virtual machine (VM), a hypervisor, or any other device configured to manage the network 130. The network controller 110 may be a software agent operating on hardware and acting on behalf of a network provider that owns the network 130. The network controller 110 is configured to define and manage data flows that occur in the data plane of the network 130. The network controller 110 maintains a full topology view of the underlying infrastructure of the network 130, computes forwarding paths through the network 130, and configures the network nodes 120 along the forwarding paths with forwarding instructions. The forwarding instructions may include a next network node 120 (e.g., next hop node) in a data flow and/or other flow processing functions. The network controller 110 sends the forwarding instructions to the network nodes 120 via the control plane (shown as dotted lines) of the network 130. In an embodiment, the network controller 110 may provide the forwarding instructions in the form of flow tables or flow table entries.

The network nodes 120 may be switches, routers, bridges, and/or any other network devices suitable for forwarding data in the network 130. The network nodes 120 are configured to receive forwarding instructions from the network controller 110 via the control plane. Based on the forwarding instructions, a network node 120 may forward an incoming packet to a next network node 120 or drop the packet. Alternatively, when receiving a packet from an unknown flow or a particular flow that is to be handled by the network controller 110, the network nodes 120 may forward the packet to the network controller 110. The network controller 110 may in turn determine a forwarding path for the packet. A well-defined controller-switch communication protocol may be defined between the network controller 110 and the network nodes 120 to enable the network controller 110 and the network nodes 120 to communicate independent from the different vendor firmware deployed in the network controller 110 and the network nodes 120.

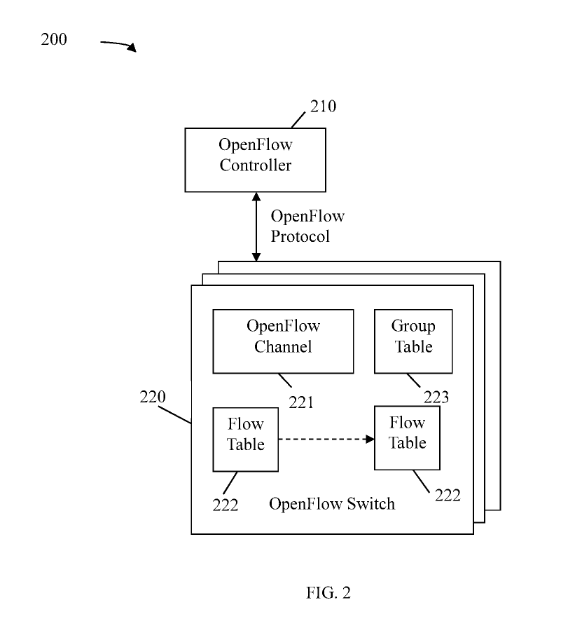

FIG. 2 is a schematic diagram of an embodiment of an OpenFlow network 200. The network 200 is substantially similar to the system 100 and provides a more detailed view of the controller-switch interactions in the system 100 via the OpenFlow protocol. The network 200 comprises an OpenFlow controller 210 and one or more OpenFlow switches 220. The OpenFlow controller 210 and the OpenFlow switches 220 are similar to the network controller 110 and the network nodes 120, respectively. The OpenFlow protocol provides standard application programming interfaces (APIs) for the OpenFlow controller 210 to interact with the OpenFlow switches 220.

Each OpenFlow switch 220 comprises an OpenFlow channel 221 or agent, one or more flow tables 222, and a group table 223. The OpenFlow channel 221 is configured to communicate commands and/or data packets between the OpenFlow controller 210 and the OpenFlow switch 220. In the network 200, the OpenFlow controller 210 sends messages, commands, and/or queries to each OpenFlow switch 220 via the OpenFlow channel 221. Similarly, the OpenFlow controller 210 receives messages, responses, and/or notifications from each OpenFlow switch 220 via the OpenFlow channel 221. For example, the OpenFlow controller 210 is configured to add, update, and/or delete flow entries in a flow table 222. In the OpenFlow protocol, the processing and forwarding of information flows that traverse an OpenFlow switch 220 are specified via the flow table 222, the group table 223, and/or a set of actions that are stored in the flow table 222 and/or the group table 223. The flow table 222 and the group table 223 are also referred to as match-action tables (MATs). A MAT entry comprises a match attribute, an action attribute, and a priority. A matching rule is a set of criteria or match conditions, for example, incoming packet header fields, for recognizing or distinguishing units of information or information flows to be processed by an OpenFlow switch 220. An action operates on units of information, for example, packets or frames, and/or information flows, for example, signals comprising a characteristic that enables them to be distinguished from other signals in an OpenFlow switch 220, such as timeslots or frequency bands. The MATs control packet processing and/or flow pipeline processing. The flow table 222 controls the processing for a particular flow (e.g., unicast packets) and the group table 223 controls the processing for a group of flows (e.g., multicast or broadcast packets). For example, when the OpenFlow switch 220 receives a packet, the OpenFlow switch 220 searches the flow table 222 for a highest-priority entry that matches the received packet and then executes the actions in the corresponding entry. In addition, the flow table 222 may further direct a flow to a group table 223 for further actions. In an embodiment, the network 200 comprises multiple flows with common flow patterns. For example, each of the flows is identified by an input port at which incoming packets are received and to which an output port the incoming packets are forwarded. Thus, the OpenFlow switch 220 is configured with multiple flow table entries comprising similar match conditions and similar actions in the flow tables 222 or the group table 223, where the flow table entries differ by port numbers only, which are specific to the flows.

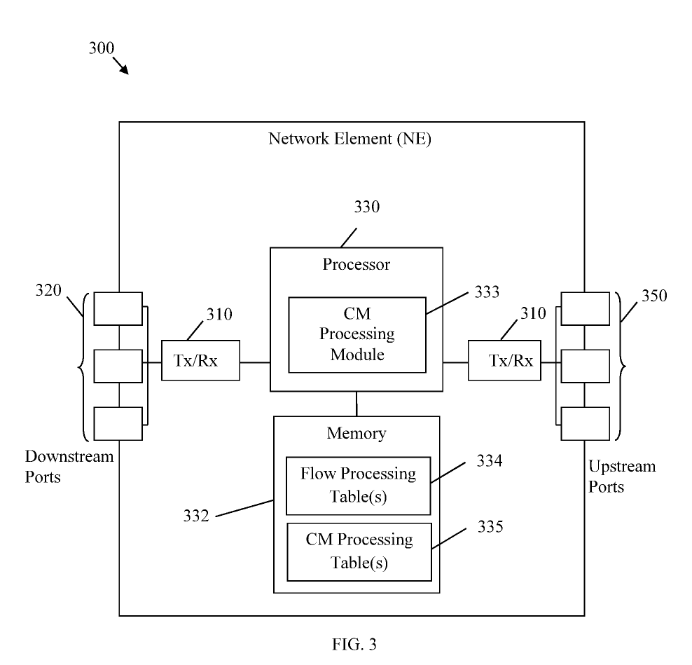

FIG. 3 is a schematic diagram of an embodiment of an NE 300. The NE 300 may act as a node, such as the network node 120, the network controller 110, the OpenFlow switch 220, or the OpenFlow controller 210, in an SDN, such as the system 100 or the network 200. The NE 300 may be configured to implement and/or support the employment of CMs to facilitate uniform programming of common flow patterns described herein. The NE 300 may be implemented in a single node or the functionality of NE 300 may be implemented in a plurality of nodes. One skilled in the art will recognize that the term NE encompasses a broad range of devices of which NE 300 is merely an example. NE 300 is included for purposes of clarity of discussion, but is in no way meant to limit the application of the present disclosure to a particular NE embodiment or class of NE embodiments. At least some of the features and/or methods described in the disclosure may be implemented in a network apparatus or module such as an NE 300. For instance, the features and/or methods in the disclosure may be implemented using hardware, firmware, and/or software installed to run on hardware. As shown in FIG. 3, the NE 300 may comprise transceivers (Tx/Rx) 310, which may be transmitters, receivers, or combinations thereof. A Tx/Rx 310 may be coupled to plurality of downstream ports 320 for transmitting and/or receiving frames from other nodes and a Tx/Rx 310 may be coupled to plurality of upstream ports 350 for transmitting and/or receiving frames from other nodes, respectively. A processor 330 may be coupled to the Tx/Rx 310 to process the frames and/or determine which nodes to send the frames to. The processor 330 may comprise one or more multi-core processors and/or memory devices 332, which may function as data stores, buffers, etc. The processor 330 may be implemented as a general processor or may be part of one or more application specific integrated circuits (ASICs) and/or digital signal processors (DSPs). The processor 330 may comprise a CM processing module 333, which may implement methods 400, 500, 600, and/or 700, as discussed more fully below, and/or any other mechanisms discussed herein. As such, the inclusion of the CM processing module 333 and associated methods and systems provide improvements to the functionality of the NE 300. Further, the CM processing module 333 effects a transformation of a particular article (e.g., the SDN) to a different state. In an alternative embodiment, the CM processing module 333 may be implemented as instructions stored in the memory devices 332, which may be executed by the processor 330. The memory device 332 may comprise a cache for temporarily storing content, e.g., a random-access memory (RAM). Additionally, the memory device 332 may comprise a long-term storage for storing content relatively longer, e.g., a read-only memory (ROM). For instance, the cache and the long-term storage may include dynamic RAMs (DRAMs), solid-state drives (SSDs), hard disks, or combinations thereof. The memory device 332 may be configured to store one or more flow processing tables 334, such as the flow tables 222, the group tables 223, and/or one or more CM processing tables 335 that stores CMs, such as the CM 800, as discussed more fully below.

It is understood that by programming and/or loading executable instructions onto the NE 300, at least one of the processor 330 and/or memory device 332 are changed, transforming the NE 300 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

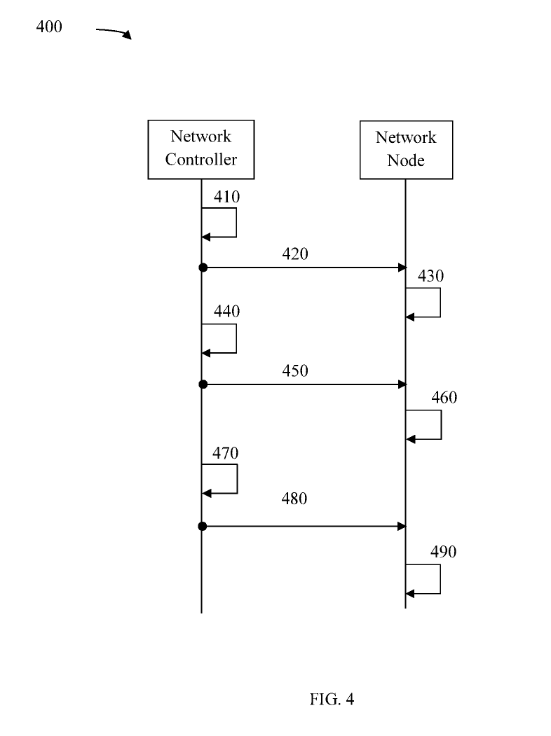

FIG. 4 is a protocol diagram of an embodiment of a method 400 for configuring a network, such as the system 100 and the network 200, comprising multiple flows with common flow patterns. The method 400 is implemented between a network controller, such as the network controller 110 and the OpenFlow controller 210, and a network node, such as the network node 120 and the OpenFlow switch 220. The method 400 is initiated by the network controller when the network controller determines that the network comprises multiple flows with a common flow pattern. Thus, a network node in the network may be configured with multiple flow table entries comprising similar match-action patterns. For example, each flow table entry comprises a match on an input port and an action to output to an output port, where the input port number and the output port number are specified according to the network node's port numbers corresponding to the flow identified by the flow table entry. As such, instead of repeatedly sending similar flow configuration commands, a network controller may abstract the similarities between the different flows into commands and represent the variable portions in terms of parameters. For example, the command specifies a match on an input port and an action to output to an output port, where the input port and the output port are represented in terms of parameters. Thus, the command may be applied to different flows that share the same flow pattern by substituting the parameters with values specific to the flows.

At step 410, the network controller identifies a common flow pattern in the network. A common flow pattern refers to a match-action pattern comprising match conditions and corresponding actions that may be employed by multiple data flows in a network. The network controller specifies the common flow pattern in the form of a CM. For example, the network controller generates a CM by assigning a CMID for identifying the CM, adding a set of commands, which take one or more command arguments, and a set of parameters to the CM, and associating at least one of the parameters with one of the command arguments. A parameter comprises at least a parameter ID that identifies the parameter. In some embodiments, the CM may associate a parameter with one or more command arguments. For example, in a command an argument may be expressed in the form of a parameter ID if the argument range admits this encoding, e.g., an argument with a string value. Alternatively, a parameter may be associated with the i^{th} command and the j^{th} command argument by associating the parameter ID with an argument represented in the form of (command i, command argument j) or any other suitable forms as determined by a person of ordinary skill in the art to achieve the same functionalities.

The commands correspond to the common flow pattern or the match-action pattern. For example, a command may specify a match on a match condition (e.g., packet header fields) and an action to be performed when a match is found. The set of parameters may correspond to variables in the match-action pattern that vary with connections. For example, when the match condition comprises a match on an input port, a parameter ID may be associated with the command argument that identifies an input port and the argument value corresponding to an input port number. The corresponding input port number may be provided later as a parameter value when the CM is invoked. In some embodiments, the network controller may provide default parameter values for some of the parameters. The parameter values are provided at run time when the CM is invoked or executed. If a parameter value is not provided when a CM is invoked, the default value for that parameter may be used. The structure of the CM is discussed more fully below. At step 420, the network controller sends a first CM configuration message comprising the CM to the network node. At step 430, upon receiving the first CM configuration message, the network node stores the CM, for example, in memory, such as the memory device 332, for later use.

At step 440, the network controller identifies a first connection for the network node, where the first connection comprises the common flow pattern. The network controller determines a set of first parameter values for the set of parameters according to the first connection. At step 450, the network controller sends a first CM invocation message to the network node to request the network node to execute the CM. For example, the first CM invocation message comprises the CMID and a parameter binding, which may be in the form of a list of parameter name-value pairs (parameter ID, first parameter value). In an embodiment, a parameter may be an input port and/or an output port and the value is a port number on the network node corresponding to the input port and/or the output port. At step 460, upon receiving the first CM invocation message, the network node executes the CM by substituting the first parameter values for the associated arguments. For example, a parameter k is associated with a command i and a command argument j, the command i is executed by replacing the command argument j value with the parameter k value. The execution of the CM results in generating one or more flow table entries for processing packets received from the first connection.

At step 470, the network controller identifies a different second connection for the network node, where the second connection comprises the common flow pattern. The network controller determines a set of second parameter values for the set of parameters in the CM according to the second connection. At step 480, the network controller sends a second CM invocation message to the network node to request the network node to execute the CM. The second CM invocation message is similar to the first CM invocation message, but comprises the second parameter values instead of the first parameter values. At step 490, upon receiving the second CM invocation message, the network node executes the CM by substituting the second parameter values for the associated arguments. For example, the second parameter values may indicate a different flow, input port, output port, etc. than the first parameter values. Similarly, the execution of the CM results in generating one or more flow table entries for processing packets received from the second connection. As shown, by employing CMs, a network controller may reduce the amount of message volume for configuring a network node by sending a CM once and invoking the CM multiple times to create multiple connections with the same flow pattern. It should be noted that the network controller may additionally reuse the same CM for a different network node by employing similar mechanisms as described in the method 400. Thus, the employment of CMs may reduce controller-switch traffic and simplify controller-switch interactions.

In an embodiment, CMs are employed for creating a point-to-point bidirectional connection. For example, a network, such as the system 100 and the network 200, comprises a bidirectional connection between a connection point A and a connection point B and employs a multiprotocol label switching (MPLS) protocol for routing. The bidirectional connection may be described in a network node, such as the network node 120 and the OpenFlow switch 220, by employing two flow table entries in a flow table, such as the flow table 222. A first flow table entry identifies a first flow from connection point A to connection point B and a second flow table entry identifies a second flow from connection point B to connection point A. For example, the first flow table entry comprises a match on the port (e.g., port 1) and the label (e.g., label X) corresponding to connection point A, and an action to set the label (e.g., label Y) for connection point B and output on the port (e.g., port 2) for connection point B. Similarly, the second flow table entry comprises a match on the port (e.g., port 2) and label (e.g., label Y) corresponding to connection point B, and an action to set the label (e.g., label X) for connection point A and output on the port (e.g., port 1) for connection point A. The first flow table entry and the second flow table entry are shown below in Table 1.

TABLE 1
Flow Table Entries for a Bidirectional Connection

| Connection Descriptions | Match | Action |
|---|---|---|
| Connection point A to B | Input Port = 1, | Set: Output Label = Y, |
| | Input Label = X | Output(Port 2) |
| Connection point B to A | Input Port = 2, | Set: Output Label = X, |
| | Input Label = Y | Output(Port 1) |

A network controller, such as the network controller 110 and the OpenFlow controller 210, may configure the bidirectional connection in the network node by employing similar mechanisms as described in the method 400. For example, the network controller configures the bidirectional connection as a single connection comprising two flows in opposite directions. The network controller creates a bidirectional connection CM and a CMID for identifying the bidirectional connection CM. The network controller adds two commands to the bidirectional connection CM. The first command specifies a match on a first port and a first label, and an action to set a second label and to output on a second port. The second command specifies a match on the second port and the second label, and an action to set the first label and to output on the first port. For example, the bidirectional connection CM, denoted as BICONN_CM, is defined with parameters, denoted as PARM_{—}1, PARM_{—}2, PARM_{—}3, and PARM_{—}4, as shown below:

BICONN_CM (PARM_{—}1, PARM_{—}2, PARM_{—}3, PARM_{—}4), where PARM_{—}1 corresponds to a first port parameter, PARM_{—}2 corresponds to a first label parameter, PARM_{—}3 corresponds to a second port parameter, and PARM_{—}4 corresponds to a second label parameter.

To create a bidirectional connection from connection point A to connection point B, the network controller invokes the bidirectional connection CM with the CMID and a set of parameter values corresponding to the bidirectional connection. For example, the first port parameter is set to port 1, the first label parameter is set to label X, the second port parameter is set to port 2, and the second label parameter is set to label Y. The invocation of the bidirectional connection CM causes the network node to execute the following:

BICONN_CM(1, X, 2, Y).

The execution of BICONN_CM(1, X, 2, Y) causes the network node to generate two flow table entries similar to the two flow table entries shown in Table 1.

To create a second bidirectional connection from a connection point C (e.g., at port 3 with label M) to a connection point D (e.g., at port 4 with label N), the network controller invokes the bidirectional connection CM with the CMID and a set of parameter values corresponding to the second bidirectional connection. For example, the first port parameter is set to port 3, the first label parameter is set to label M, the second port parameter is set to port 4, and the second label parameter is set to label N. The invocation of the bidirectional connection CM causes the network node to execute the following:

BICONN_CM (3, M, 4, N).

The execution of BICONN_CM (3, M, 4, N) causes the network node to generate two flow table entries similar to the two flow table entries shown in Table 1, but with the port numbers and labels set to the parameter values of the second bidirectional connection.

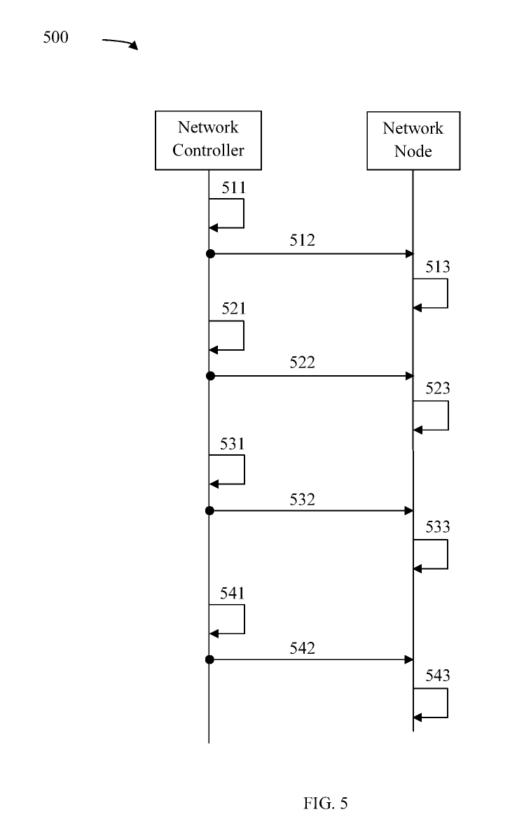

FIG. 5 is a protocol diagram of an embodiment of a method 500 for associating multiple controls that operate on a network connection. The method 500 is implemented between a network controller, such as the network controller 110 and the OpenFlow controller 210, and a network node, such as the network node 120 and the OpenFlow switch 220, in a network, such as the system 100 and the network 200. The method 500 is similar to the method 400, but further improves efficiency by storing parameter bindings, which may be reused later. At step 511, the network controller and/or a network administrator identifies a first flow pattern in the network. The network controller creates a first CM and a first CMID for identifying the first CM. The network controller adds the first CMID, one or more first commands and one or more first parameters, identified by first parameter IDs, to the first CM according to the first flow pattern. At step 512, the network controller sends a first CM configuration message comprising the first CM to the network node. At step 513, upon receiving the first CM configuration message, the network node saves the first CM, for example, in a memory device such as the memory device 332.

At step 521, the network controller identifies a connection for the network node, where the connection is associated with the first flow pattern. At step 522, the network controller sends a first CM invocation message to the network node to request the network node to execute the first CM. For example, the first CM invocation message comprises the first CMID, a set of first parameter values for the first parameter IDs corresponding to the connection, and a BID that binds the first parameter IDs to the first parameter values (e.g., in parameter name-value pairs). Thus, the parameter name-value pairs represented by the BID correspond to the connection. At step 523, upon receiving the first CM invocation message, the network node executes the first CM by substituting the first parameter values for the associated arguments. The execution of the CM results in generating one or more flow table entries for processing packets received from the connection. In addition, the network node stores the BID and the parameter bindings (e.g., the list of parameter name-value pairs), for example, in the memory device, for later use.

At step 531, the network controller determines a second flow pattern in the network. Similarly, the network controller creates a second CM and a second CMID for identifying the second CM, adds the second CMID, one or more second commands and one or more second parameters, identified by second parameter IDs, to the second CM according to the second flow pattern. At step 532, the network controller sends a second CM configuration message comprising the second CM to the network node. At step 533, upon receiving the second CM configuration message, the network node saves the second CM, for example, in the memory device 332.

At step 541, the network controller determines to add the second flow pattern to the connection of the network node. For example, the second flow pattern may correspond to a different flow associated with the connection or a modification to an existing flow in the connection. At step 542, the network controller sends a second CM invocation message to request the network node to execute the second CM. For example, the second CM invocation message comprises the second CMID and the BID. It should be noted that at least one of the second parameter IDs is the same as one of the first parameter IDs such that the BID may be employed in the second CM invocation message. At step 543, upon receiving the second CM invocation message, the network node executes the second CM by obtaining a value for at least one of the second parameters from the parameter bindings corresponding to the BID and substituting the value for the associated arguments. It should be noted that since the BID binds the parameters and values for the connection, the BID may be employed by any subsequent invocations of any CMs directed to the same connection instead of resending the parameter values. As such, a BID acts as a connection ID (CID) for identifying a connection. Thus, parameter bindings may further improve efficiency in network controllers and network nodes. In addition, parameter bindings enable association between different related CMs.

In an embodiment, CMs and parameter bindings are employed for creating and managing a bidirectional connection between a first connection point (e.g., at a first port with a first label) and a second connection point (e.g., at a second port with a second label), which is similar to the bidirectional connection described in Table 1. For example, a network controller, such as the network controller 110 and the OpenFlow controller 120, defines a bidirectional connection CM, denoted by BICONN_CM, identified by a first CMID and comprises parameters, denoted as PARM_{—}1, PARM_{—}2, PARM_{—}3, and PARM_{—}4, as shown below:

BICONN_CM (PARM_{—}1, PARM_{—}2, PARM_{—}3, PARM_{—}4),

where PARM_{—}1 corresponds to a first port parameter, PARM_{—}2 corresponds to a first label parameter, PARM_{—}3 corresponds to a second port parameter, and PARM_{—}4 corresponds to a second label parameter.

To create a bidirectional connection between connection point A (e.g., at port 1 with label X) and connection point B (e.g., at port 2 with label Y), the network controller invokes the bidirectional connection CM with the first CMID and employs a BID to represent a binding between the parameters and the values. For example, a BID, denoted as BID_AB, binds the first port parameter to port number 1, the first label parameter to label X, the second port parameter to port number 2, and the second label parameter to label Y. Thus, the invocation of the bidirectional connection CM causes a network node, such as the network node 120 and the OpenFlow switch 220, to execute the following:

BICONN_CM(BID_AB, 1, X, 2, Y).

The execution of BICONN_CM(BID_AB, 1, X, 2, Y) causes the network node to generate two flow table entries similar to the two flow table entries shown in Table 1. In addition, the network node stores the parameter bindings and the association of the BID with the parameter bindings, for example, in a memory device, such as the memory device 332, such that the values may be employed for the parameters in subsequent BID references. For example, the network controller subsequently defines a monitoring CM for performing the subnetwork connection monitoring and a second CMID for identifying the monitoring CM. For example, the network controller invokes the monitoring CM by providing the second CMID and the BID_AB. The invocation of the monitoring CM, denoted by MON_CM, causes the network node to execute the following:

MON_CM(BID_AB).

The network controller may subsequently define a third CM to lock a first connection point, for example, to stop traffic from entering the first connection point, of a bidirectional connection and a fourth CM to unlock a first connection point, for example, to allow traffic to enter the first connection point, of a bidirectional connection. For example, the network controller may invoke the third CM by referencing BID_AB to lock connection point A. Alternatively, the network controller may invoke the fourth CM by referencing BID_AB to unlock connection point A.

In an embodiment, CMs and parameter bindings are employed for creating and managing a protected optical data unit (ODU) connection. For example, the protected ODU connection comprises a normal port, a working port, and a protection port. The normal port receives data to be protected, the working port carries the data to a destination node via a working path, and the protection port carries a copy of the data to the destination node via a protected path. When the working path fails, the destination node may receive a copy of the data from the protection path. In addition, the protected ODU connection may be monitored by performing tandem connection monitoring on the working port and the protection port. Thus, a protected ODU connection may be configured with at least three flow table entries. For example, a first flow table entry matches the normal connection point and configures a protection function for the normal connection point, a second flow table entry matches the working connection point and configures a monitoring function and the same protection function for the working connection point, and a third flow table entry matches the working connection point and configures a monitoring function and the same protection function for the protection connection point. For example, the normal port is at port 1 and operates on traffic in time slot (TSs) A, the working port is at port 2 and operates on traffic in TSs B, the protection port is at port 3 and operates on traffic in TSs C, and all tandem monitoring is performed at tandem connection monitoring (TCM) level 2 by a downstream maintenance point (MP) (e.g., towards a network interface). Thus, the flow table entries for the protected ODU connection may be as shown below in Table 2. It should be noted that the downstream MP may be configured by indicating a direction of operation (e.g., Direction=down).

TABLE 2
Flow Table Entries for a protected ODU Connection

| Match | Actions |
|---|---|
| Port = 1, TS = A | protect(ID = K, Role = Normal) |
| Port = 2, TS = B | monitor(ID = X, TCM Level = 2, Direction = Down) |
| | protect(ID = K, Role = Working, MP = X) |
| Port = 3, TS = C | monitor(ID = Y, TCM Level = 2, Direction = Down) |
| | protect(ID = K, Role = Protection, MP = Y) |

A network controller, such as the network controller 110 and the OpenFlow controller 210, may configure the protected ODU connection in a network node, such as the network node 120 and the OpenFlow switch 220, by employing similar mechanisms as described in the methods 400 and 500. For example, the network controller defines a protection CM for a protected ODU connection, where the protection CM is identified by a CMID and comprises three commands corresponding to the flow configurations shown in Table 2. A first command specifies a match on a normal port and a normal TS, and an action to configure a protection function with a protection role of normal. A second command specifies a match on a working port and a working TS, and an action to configure a down MP to monitor the working path at TCM level 2 and configure a protection function with a protection role of working. A third command specifies a match on a protection port and a protection TS, and an action to configure a down MP to monitor the protection path at TCM level 2 and configure a protection function with a protection role of protection. For example, the protection CM, denoted as PROT_CM, is defined with a default value of 2 for the TCM level, a default direction of DOWN for the MP direction and comprises input arguments, denoted as PARM_{—}1, PARM_{—}2, PARM_{—}3, PARM_{—}4, PARM_{—}5, PARM_{—}6, and PARM_{—}7, as shown below:

PROT_CM(PARM_{—}1, PARM_{—}2, PARM_{—}3, PARM_{—}4, PARM_{—}5, PARM_{—}6, PARM_{—}7),

where PARM_{—}1 corresponds to a normal port parameter, PARM_{—}2 corresponds to a normal TS parameter, PARM_{—}3 corresponds to a working port parameter, PARM_{—}4 corresponds to a working TS parameter, PARM_{—}5 corresponds to a protection port parameter, PARM_{—}6 corresponds to a protection TS parameter, and PARM_{—}7 corresponds to a TCM level with a default value of 2.

To create the ODU protected connection, the network controller invokes the protection CM with the CMID and a set of parameter values corresponding to the ODU protected connection. For example, the normal port parameter is set to port 1, the normal TS parameter is set to TS A, the working port parameter is set to port 2, the working TS parameter is set to TS B, the protection port parameter is set to port 3, and the protection TS parameter is set to TS C. The network controller may additionally bind the set of values to the parameters and assign a BID, denoted as BID_protected, to the binding. The invocation of the protection CM causes the network node to execute the following:

PROT_CM(BID_protected, 1, A, 2, B, 3, C).

The execution of the protection CM causes the network node to generate three flow table entries similar to the flow table entries shown in Table 2. Note that PARM_{—}7 is not provided in the CM invocation shown and therefore takes the default value 2 as provided in the CM definition.

Subsequently, the network controller may modify an existing flow pattern in the ODU protection connection or add another flow with a different flow pattern to the ODU protected connection by referencing BID_protected when invoking other CMs. In addition, the ODU protected connection may be deleted by a connection deletion command referencing BID_protected. For example, a connection deletion command referencing BID_protected causes the network node to delete all flow table entries (e.g., all three flow table entries) associated with BID_protected. It should be noted that the deletion of a connection deletes an instance created using the CM, but does not delete the CM. For example, a protection CM may protect multiple flows by invocation of multiple instances (e.g., with different BIDs). A CM is deleted by a deletion command referencing the CMID that identifies the CM.

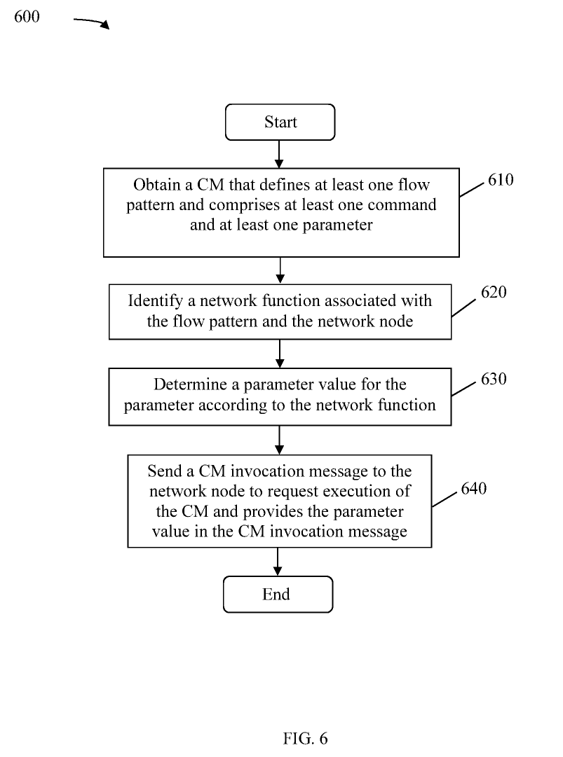

FIG. 6 is a flowchart of an embodiment of a method 600 for configuring a network, such as the system 100 and the network 200, comprising multiple flows with common flow patterns. The method 600 is implemented by a network controller, such as the network controller 110 and the OpenFlow controller 120, or a network node, such as the NE 300. The method 600 employs similar mechanisms as described in the methods 400 and 500. The network controller implements the method 600 when determining a common flow pattern in the network, for example, based on network administrator input. For example, the flow pattern is associated with a bidirectional connection or a protected connection as described above. At step 610, a CM that defines a common flow pattern is obtained, for example, by the network controller. The CM is identified by a CMID. The CM comprises at least one command and at least one parameter associated with the command, for example, at least one of the commands takes an argument corresponding to the parameter. For example, the command specifies a match on an input, and the parameter is an input port. In some embodiments, the network controller may send a CM configuration message comprising the CM to a network node, such as the network node 120 and the OpenFlow switch 220. At step 620, a network function is identified in the network, where the network function is associated with the flow pattern and the network node. For example, the network function is associated with one or more flows, and the flow pattern corresponds to at least one of the flows in the network function. In some embodiments, the network function is associated with a network connection. In some other embodiments, the network function is associated with a network management operation. At step 630, a parameter value is determined for the parameter according to the network function. For example, when the parameter is an input port, the parameter value is a port number on the network node at which the packets from the flow are received by the network node. At step 640, a CM invocation message is sent to the network node to request execution of the CM at the network node. The CM invocation message comprises the CMID, the parameter value for the parameter, and/or a BID. For example, the parameter value is bound to the parameter, and the BID represents the parameter binding. The CM invocation message enables the network node to establish the network function. For example, the network node substitutes the parameter value for the argument (e.g., argument=parameter value) when executing the command in the CM. It should be noted that the argument associated with the command is unresolved when the CM is first defined, but resolved at run time when the CM is invoked, for example, when the parameter value for the argument is provided in the CM invocation message at step 640.

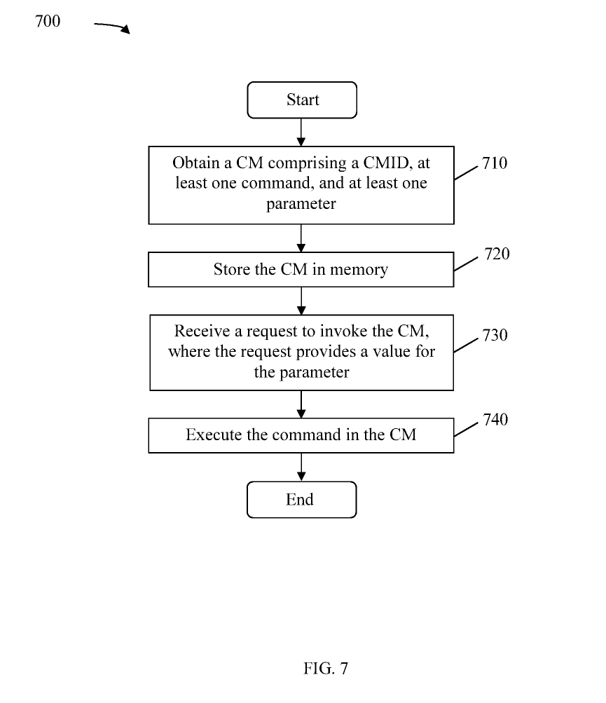

FIG. 7 is a flowchart of an embodiment of a method 700 for processing CMs. The method 700 is implemented by a network node, such as the network nodes 120, the OpenFlow switch 220, or the NE 300, operating in a network, such as the system 100 and the network 200. For example, the network comprises multiple flows with a common flow pattern. Thus, a network controller, such as the network controller 110 and the OpenFlow controller 210, may employ CMs to communicate the common flow pattern to the network node and subsequently request the network node to execute the CMs for establishing flows that share the common flow pattern. At step 710, a CM comprising a CMID, at least one command, and at least one parameter is obtained, for example, received from the network controller, pre-configured, or obtained from other network entities. The CMID identifies the CM. The command defines a flow pattern and takes at least one argument, which corresponds to the parameter. For example, the parameter may be an input port. At step 720, the CM is stored in memory, such as the memory device 332, for later use. At step 730, a request to invoke the CM is received, for example, from the network controller. The request provides a BID and/or a parameter value for the parameter, where the parameter value corresponds to a specific network function (e.g., a network connection or a management function) on the network node. For example, when the parameter is an input port, the parameter value corresponds to a port number at which packets arrive at the network node for the connection. At step 740, in response to the request, the command in the CM is executed by substituting the parameter value received from the request for the argument. When the command is executed, one or more flow table entries are generated, where the flow table entries are associated with a flow associated with the specific network function.

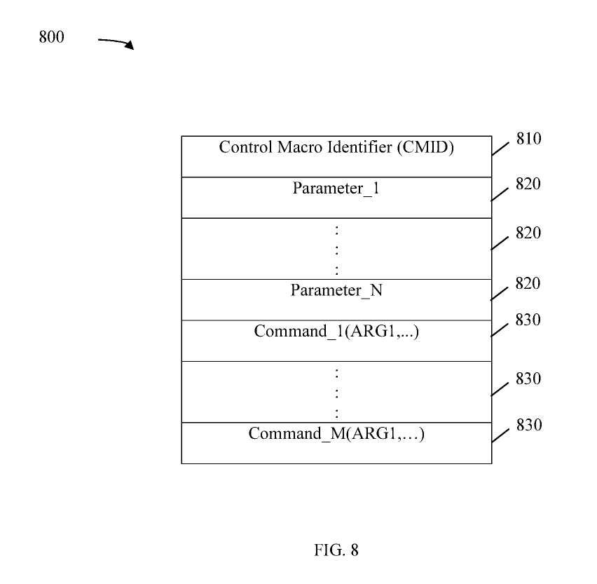

FIG. 8 is a schematic diagram of an embodiment of a CM 800 structure. The CM 800 is employed by a network controller, such as the network controller 110 and the OpenFlow controller 210, to communicate common flow patterns to a network node, such as the network node 120 and the OpenFlow switch 220, in a network, such as the system 100 and the network 200, as described in the methods 400, 500, 600, and 700. The flow patterns are definitions of matching rules and corresponding actions for processing packets and/or frames. For example, the flow pattern may be similar to a MAT entry in the flow table 222 or the group table 223. However, flow patterns are defined in terms of parameters and are not directed towards a particular connection or a particular flow in the network. By parameterizing flow patterns, the flow patterns may be applied to multiple flows or connections sharing the same flow patterns by substituting the parameters with connection-specific and/or flow-specific values.

The CM 800 structure comprises a CMID 810, one or more parameters 820, and one or more commands 830. The CMID 810 identifies the CM 800. Each parameter 820 comprises a parameter identifier (ID), which identifies the parameter 820. The parameter 820 may optionally comprise a parameter type, a default value, and/or an association with one or more command arguments (e.g., in the form of (command i, argument j)). The parameter type indicates the type of values associated with the parameter 820. For example, when the parameter ID is an input port, the parameter type is a port number type. When invoking the CM 800, the default value may be used in place of the parameter 820. Each command 830 comprises a command type and one or more arguments. For example, a command type may indicate a creation or modification of a flow table entry or a group table entry. Each argument comprises an argument ID and an argument value. The argument ID identifies the argument and the argument value specifies a value for the argument. For example, a command 830 defines a table entry and accepts an argument associated with at least one of the parameters 820. The argument value may comprise a value or a parameter ID. For example, when the argument value comprises a value and the argument is not associated with a parameter, the value is used for the argument upon execution of the command 830. Alternatively, when the argument value comprises a parameter ID or a parameter is associated with the argument, the parameter value (e.g., obtained from a CM invocation) corresponding to the parameter ID is substituted for the argument upon execution of the command 830. The parameters 820 and/or the arguments of the commands 830 may be represented in various forms, for example, as a type-length-value (TLV) structure, explicit identifications by argument or parameter names, or an ordered list of values identified by the argument or parameter positions as supplied with a command or CM invocation, and may comprise various types of values. The CM 800 may be constructed or organized as shown or alternatively configured as determined by a person of ordinary skill in the art to achieve the same functionalities.

In an embodiment, the CM 800 is invoked by providing the CMID 810 and values for the parameters 820, for example, in the form of parameter ID-value pairs. The invocation of the CM 800 causes execution of the commands 830 with the values substituted for the parameters 820. In another embodiment, the CM 800 is invoked with an additional BID. In such an embodiment, the addition of the BID provides parameter bindings between the parameter IDs and the values, where the parameter bindings correspond to a particular connection. As such, the BID acts as a CID. Thus, other control operations may be applied to the connection by defining other CMs and invoking the other CMs by referencing the BID instead of providing the same values for the parameters 820. In addition, by associating multiple CM invocations via BID enables seamless multiple controls over a connection. In some embodiments, the CM 800 is invoked with a BID and additional parameters 820. For example, the CM 800 is invoked with an additional parameter 820 comprising a parameter ID and a parameter value. When the parameter ID of the parameter 820 matches a parameter ID of the parameter bindings represented by the BID, the parameter value of the additional parameter 820 overrides the value of the corresponding parameter ID in the parameter binding.

The execution of the commands 830 causes an addition of one or more flow table entries, such as the flow table entries shown in Tables 1 and 2, to a flow table, such as the flow table 222, group table 223, and Tables 1 and 2. A connection is deleted by referencing a BID. A connection deletion causes a deletion of all flow entries associated with the connection or the BID from the flow table. The CM 800 is deleted by referencing the CMID 810.

In an embodiment, the CM 800 is invoked as an atomic command. For example, the commands 830 are all executed successfully or all executions of the commands are aborted when one of the commands 830 fail to execute successfully. As such, the configuration states among multiple related controls may remain consistent over a connection.

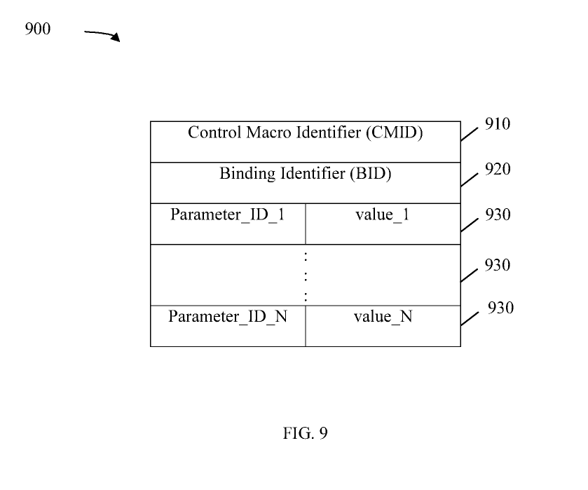

FIG. 9 is a schematic diagram of an embodiment of a CM invocation 900 structure. The CM invocation 900 may be employed in the methods 400, 500, 600, and 700 by a network controller, such as the network controller 110 and the OpenFlow controller 210 to request a network node, such as the network node 120 and the OpenFlow switch 220 to execute a CM, such as the CM 800. The CM invocation 900 comprises a CMID 910, a BID 920, and a plurality of parameter ID-value pairs 930. The CMID 910 identifies the CM for execution. The BID 920 represents the list of parameter ID-value pairs 930. Each parameter ID-value pair 930 comprises a parameter ID and a parameter value. For example, the parameter IDs in the parameter ID-value pairs 930 correspond to the parameters, such as parameters 820, included in the definition of the requested CM. When the requested CM is executed, the parameter values are substituted for the arguments associated with the corresponding parameter IDs. It should be noted that a network node may store the BID 920 in association with the parameter ID-value pairs 930 for later use. For example, when the BID 920 is associated with a network connection on a network node, a network controller may subsequently invoke a CM for the network connection by referencing the BID 920.

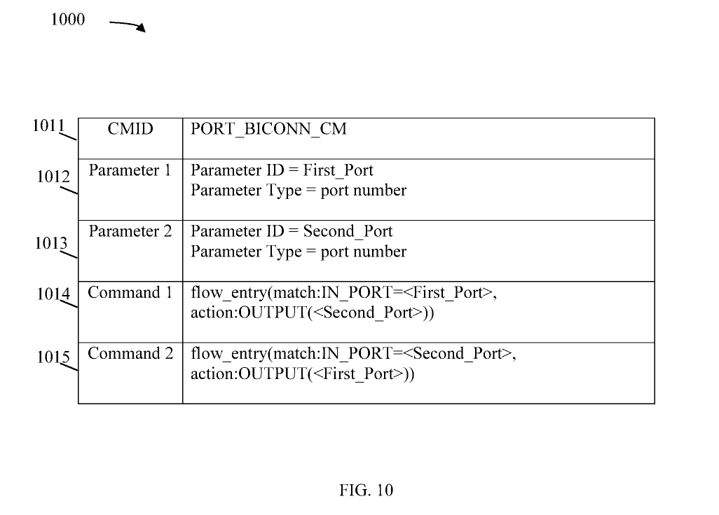

FIG. 10 illustrates an embodiment of a CM 1000 definition with parameter IDs in place of command argument values. The CM 1000 may be employed in the methods 400, 500, 600, and 700 by a network controller, such as the network controller 110 and the OpenFlow controller 210 to provide a network node, such as the network node 120 and the OpenFlow switch 220, with the CM 1000 definition. The CM 1000 may be stored at a network node after receiving and/or obtaining the CM 1000. The CM 1000 comprises a substantially similar structure as the CM 800, and employs parameter IDs in place of command argument values. The CM 1000 comprises a CMID 1011, a first parameter 1012, a second parameter 1013, a first command 1014, and a second command 1015. The CMID 1011 identifies the CM 1000. The first parameter 1012 indicates a parameter ID that identifies a parameter, First_Port. The second parameter 1013 indicates a parameter ID that identifies a parameter, Second_Port. Both the first parameter 1012 and the second parameter 1013 take parameter values with a port number type. The first command 1014 specifies a match in terms of the first parameter 1012 and an action in terms of the second parameter 1013. Similarly, the second command 1015 specifies a match in terms of the second parameter 1013 and an action in terms of the first parameter 1012. As shown, the commands 1014 and 1015 employ the parameter IDs of the first parameter 1012 and the second parameter 1013 in place of the command argument values directly.

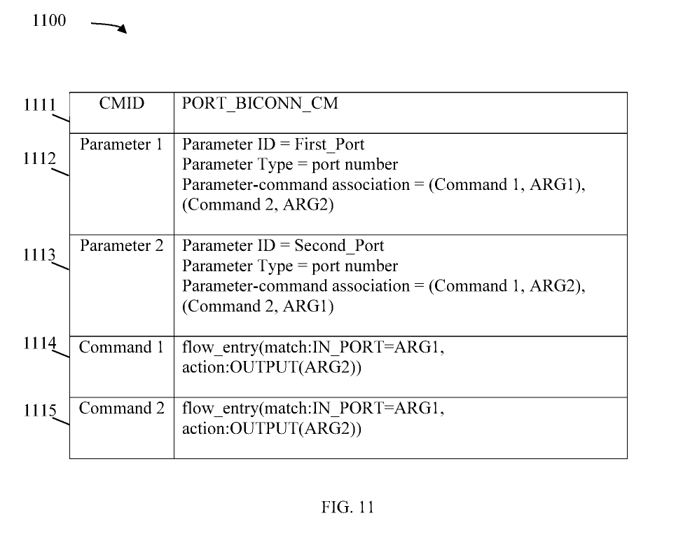

FIG. 11 illustrates an embodiment of a CM 1100 definition with parameter association. The CM 1100 may be employed in the methods 400, 500, 600, and 700 by a network controller, such as the network controller 110 and the OpenFlow controller 210 to provide a network node, such as the network node 120 and the OpenFlow switch 220, with the CM 1100 definition. The CM 1100 may be stored at a network node after receiving and/or obtaining the CM 1100. The CM 1100 comprises a substantially similar structure as the CM 800 and 1000, and provides parameter associations. The CM 1100 comprises a CMID 1111, a first parameter 1112, a second parameter 1113, a first command 1114, and a second command 1115. The CMID 1111 identifies the CM 1100. The first parameter 1112 is similar to the first parameter 1012, but additionally indicates a first parameter association with the first command 1114 and a first argument, ARG1, of the first command 1114, and a second parameter association with the second command 1115 and a second argument, ARG2, of the second command 1115. The second parameter 1113 is similar to the second parameter 1013, but additionally indicates a first parameter association with the first command 1114 and a second argument, ARG2, of the first command 1114, and a second parameter association with the second command 1115 and a first argument, ARG1, of the second command 1115. The first command 1114 specifies a match in terms of a first argument ARG1 and an action in terms a second argument, ARG2, where ARG1 corresponds to the first parameter 1112 and ARG2 corresponds to the second parameter 1113. The second command 1115 specifies a match in terms of a first argument ARG1 and an action in terms a second argument, ARG2, where ARG1 corresponds to the second parameter 1113 and ARG2 corresponds to the first parameter 1112.

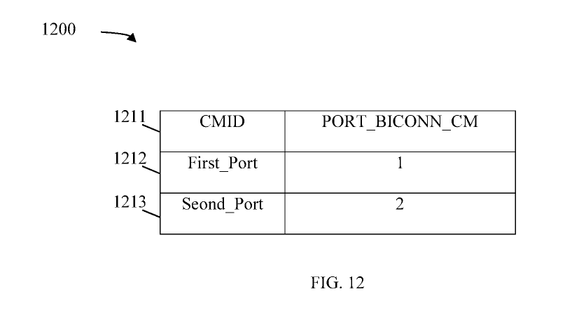

FIG. 12 illustrates an embodiment of a CM invocation 1200. The CM invocation 1200 may be employed in the methods 400, 500, 600, and 700 by a network controller, such as the network controller 110 and the OpenFlow controller 210 to request a network node, such as the network node 120 and the OpenFlow switch 220 to execute a CM, such as the CM 800, 1000, and 1100. The CM invocation 1200 comprises a CMID 1211, a first parameter ID-value pair 1212, and a second parameter ID-value pair 1213. The CMID 1211 is set to PORT_BICONN_CM, which identifies a CM, for example, the CM 1000 or 1100. The first parameter ID-value pair 1212 provides a port number of 1 for the parameter, First_Port. The second parameter ID-value pair 1213 provides a port number of 2 for the parameter, Second_Port. In an embodiment, the CMID 1211 identifies the CM 1000. Thus, the CM invocation 1200 causes the commands 1014 and 1015 to be executed with argument values of 1 for First_Port and 2 for Second_Port. In another embodiment, the CMID 1211 identifies the CM 1100. Thus, the CM invocation 1200 causes the first command 1114 to be executed with argument values of 1 for ARG1 and 2 for ARG2, and the second command 1115 to be executed with argument values of 2 for ARG1 and 1 for ARG2.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method implemented by a network controller in a software-defined network (SDN), the method comprising:
obtaining a first control macro (CM) that defines at least one first flow pattern, wherein the first CM comprises at least one command and at least one parameter associated with the command;
identifying a first network function associated with the first flow pattern and a first network node;
determining a parameter value for the parameter according to the first network function; and
sending a first CM invocation message to the first network node to request execution of the first CM to establish the first network function, wherein the first CM invocation message comprises the parameter value.

2. The method of claim 1, further comprising:
binding the parameter value to the parameter to produce a parameter binding corresponding to the first network function; and
associating a binding identifier (BID) with the parameter binding, wherein the first CM invocation message further comprises the BID.

3. The method of claim 2, further comprising:
obtaining a second CM that defines a second flow pattern;
determining that the first network function is associated with the second flow pattern; and
sending a second CM invocation message to the first network node to request execution of the second CM to modify the first network function, wherein the second CM invocation message indicates the first network function by referencing the BID.

4. The method of claim 3, wherein the second CM invocation message requests the first network node to modify the first connection by simultaneously modifying a plurality of flow table entries associated with the BID.

5. The method of claim 2, further comprising sending a deletion message to the first network node to request deletion of the first network function by deleting all flow table entries associated with the first network function, wherein the deletion message indicates the first network function by referencing the BID.

6. The method of claim 1, wherein the first CM is identified by a CM identifier (CMID), wherein the method further comprises sending a CM deletion message to the first network node to request deletion of the first CM, and wherein the CM deletion message indicates the first CM by referencing the CMID.

7. The method of claim 6, further comprising:
sending a CM configuration message to a second network node in the network, wherein the CM configuration message comprises the same first CM identified by the same CMID, and wherein the second network node is different from the first network node; and
sending a second CM invocation message to the second network node to request execution of the first CM to establish a second network function associated with the first flow pattern.

8. The method of claim 1, wherein the network controller is an OpenFlow protocol-enabled network controller, and wherein the first network function is associated with a connection in the SDN.

9. The method of claim 1, wherein the network controller is a network configuration (NETCONF) protocol-enabled network controller, and wherein the first network function is associated with a network management function in the SDN.

10. A network element (NE) comprising:
a receiver configured to couple to a software-define network (SDN) controller;
a memory configured to store a flow table; and
a processor coupled to the memory and the receiver, wherein the processor is configured to:
obtain a first control macro (CM) comprising a CM identifier (CMID) that identifies the first CM, at least one command, and at least one parameter associated with the command, wherein the first CM defines a first flow pattern;
store the first CM in the memory;
receive, via the receiver, a first CM request from the SDN controller to invoke the first CM, wherein the first CM request indicates a value for the parameter, and wherein the value is associated with a network function on the NE; and
execute the command in the first CM by substituting the value for the parameter in response to the first CM request, wherein executing the command causes an addition of at least a first flow table entry in the flow table, and wherein the first flow table entry identifies a flow associated with the first flow pattern and the network function.

11. The NE of claim 10, wherein the first CM further comprises a binding identifier (BID) in association with a binding of the parameter to the value, and wherein the processor is further configured to store the BID and the binding in the memory.

12. The NE of claim 11, wherein the processor is further configured to:
receive, via the receiver, a second CM that defines a second flow pattern;
receive, via the receiver, a second CM request to invoke the second CM, wherein the second CM request indicates the BID; and
execute the second CM according to the binding associated with the BID in response to the second CM request, wherein executing the second CM causes an update associated with the network function in the flow table, and wherein the update comprises a flow table entry addition, a flow table entry modification, or combinations thereof.

13. The NE of claim 11, wherein the processor is further configured to:
receive, via the receiver, a deletion request to delete the network function, wherein the deletion request references the BID; and
delete the network function in response to the deletion request, wherein deleting the network function causes deletion of flow table entries associated with the network function from the flow table.

14. The NE of claim 10, wherein the processor is further configured to:
receive, via the receiver, a CM deletion request to delete the first CM, wherein the CM deletion request references the CMID; and
delete the first CM from the memory in response to the CM deletion request.

15. The NE of claim 10, wherein the first flow pattern is associated with a bidirectional connection, a protected connection, or combinations thereof, and wherein the parameter is associated with a port number.

16. A computer program product for use by a software-defined network (SDN)-enabled network node, wherein the computer program product comprises computer executable instructions stored on a non-transitory computer readable medium that when executed by a processor causes the SDN-enabled network node to:
receive a control macro (CM) comprising:
a CM identifier (CMID) that identifies the CM;
a first parameter; and
a plurality of commands, wherein at least one of the commands comprises a first argument associated with the first parameter;
store the CM in a memory device; and
receive a request to invoke the CM for configuring a network function,
wherein the request provides a parameter value for the first parameter, and
wherein the parameter value is associated with the network function.

17. The computer program product of claim 16, wherein the first parameter comprises a default value for the first parameter, a parameter type that indicates a type of values for the first parameter, an association with the first argument, or combinations thereof.

18. The computer program product of claim 16, wherein the CM further comprises a second parameter comprising a default value, wherein at least one of the commands comprises a second argument associated with the second parameter, wherein the request does not include a value for the second parameter, and wherein the instructions further cause the processor to execute the CM by substituting the default value for the second argument in response to the request.

19. The computer program product of claim 16, wherein the first parameter is identified by a parameter identifier (ID), wherein the first argument indicates the parameter ID, and wherein the instructions further cause the processor to execute the CM by substituting the parameter value for the first argument in response to the request.

20. The computer program product of claim 16, wherein the instructions further cause the processor to:
execute all the commands in the CM; and
abort all executions of the commands when one of the commands fails to execute successfully.
